(19) United States
(12) Patent Application Publication
(10) Pub. No.: US 2015/0163739 A1
(43) Pub. Date: Jun. 11, 2015

(54) METHODS AND APPARATUSES FOR ENABLING DYNAMIC SCHEDULING REQUEST TIMING INTERVAL|DURING DISCONTINUOUS RECEPTION

(71) Applicant: BROADCOM CORPORATION, Irvine, CA (US)

(72) Inventors: Jianke Fan, Espoo (FI); Jari Isokangas, Tampere (FI)

(73) Assignee: BROADCOM CORPORATION, Irvine, CA (US)

(21) Appl. No.: 14/411,775

(22) PCT Filed: Jun. 28, 2013
(86) PCT No.: PCT/IB2013/055336

§ 371 Date: Dec. 29, 2014

(30) Foreign Application Priority Data
Jun. 29, 2012 (GB) 1211613.3

(51) Int. Cl. H04W 52/02; H04W 72/04

(52) U.S. Cl. CPC H04W 52/0216; H04W 72/0446; H04W 72/0413

(57) ABSTRACT

Apparatuses, methods, computer software and computer program products for improving DRX and scheduling request configuration for diverse data applications. Information associated with data in a buffer is determined (S11) in a user equipment and transmitted (S12) to a base station. The base station sets an appropriate DRX and a data scheduling request timing interval based thereon and transmits (S13) data scheduling request timing interval information for discontinuous reception control to the user equipment. The user equipment transmits (S14) a data scheduling request to the base station at the received data scheduling request timing interval.

### TECHNICAL FIELD

The present disclosure generally relates to wireless communication, and more specifically relates to techniques for improving discontinuous reception DRX and scheduling request SR configuration for diverse data applications.

### BACKGROUND

In present communication systems, a large number of communication devices, such as cell (or ‘mobile’) phones, smartphones, tablet-pc or laptop-pc, etc, are portable, so that efficient power saving schemes are necessary for increasing the operating times of such portable battery powered devices.

One approach for enabling improved power saving is discontinuous reception DRX. In discontinuous reception mode, a portable device periodically receives data at specific reception intervals, whereas the device does not receive any data at idle intervals. Specifically, DRX defines periods when a user equipment UE, for example, listens to a physical downlink control channel PDCCH, which then may indicate that there is some data for the UE. The reception of data can then continue for longer than a previously defined DRX on-duration period. Thereby, the communication system may enable DRX mode of a portable device to save battery power when the system estimates that the portable device does not need to receive any transmission from a base station in every radio subframe.

The requirements of how to improve the management efficiency in uplink control channel resource for connected mode user equipments UEs that are temporarily inactive, as well as lower power consumption, are becoming widely noticed issues.

At RAN#53, a work item called “LTE RAN enhancements for diverse data applications” was approved, an objective of which targets RAN (radio access network) improvement for applications, such as small data transmission and background data transmission. The enhancements identified for the work item are as follows:
1. Enhancements within existing radio resource control RRC states, to RRC state-control mechanisms and radio resource management RRM mechanisms that offer system efficiency improvements and/or reduced user equipment UE power consumption for devices exhibiting a continued but intermittent data activity.
2. Enhancements to DRX configuration/control mechanisms to be more responsive to the needs and activity of either single or multiple applications running in parallel, with improved adaptability to time-varying traffic profiles and to application requirements, thereby allowing for an improved optimization of the trade-off between performance and UE-battery-consumption.
3. More efficient management of system resources (e.g. uplink UL control channel resources) for connected mode UEs that are temporarily inactive, facilitating potentially larger user populations in connected mode.
4. For the above enhancements, knowledge from both the UE and the network should be taken into account where possible.

It was observed in reference [3] that physical uplink control channel PUCCH resources are mainly allocated for SR and channel quality indicator CQI (channel quality indicator), PMI (precoding matrix indicator) and/or RI (rank indicator) reporting. When DRX is applied a certain amount of PUCCH resources allocated for SR is wasted depending on DRX and SR configurations. Hence schemes to improve the resource efficiency at SR transmission for non-periodic background traffic would be needed.

In present Long-Term Evolution LTE systems, a terminal supplies a base station eNB with information about the data in its buffers using two mechanisms: 1-bit scheduling request SR and buffer status reports BSR. SR is transmitted on a control channel (physical uplink control channel PUCCH or radio access channel RACH) while the BSR is transmitted on the data channel (physical uplink shared channel PUSCH) mostly together with user data. In current systems, the SR resource may be configured with a period and one subframe offset. The period of SR can be 1 ms, 2 ms, 5 ms, 10 ms, 20 ms, 40 ms or 80 ms.

If there are many applications and UEs existing in a system, an efficient use of the uplink UL control resource might be a problem. In a current system, the number is up to 36 UEs, but in practice a reasonable number is only 18 UEs that can be given different cyclic shift and orthogonal spreading to provide different SR resources in one resource block RB.

Current applications in UEs exist, which apply so-called background traffic data transmission, which means that the data is transmitted without any user activity. In such situation, the user does not have total control of transmitted data. In current LTE systems, when a packet arrives at a UE, it would trigger periodic SR to request UL resource for data transmission. This may cause waste of SR transmission or cause loss or delay of the data.

Hence, measures to improve the resource efficiency of SR transmission for non-periodic background traffic would be desirable. Embodiments of the present disclosure provide improvements over present SR and DRX procedures of LTE.

### REFERENCES

[1] 3GPP TS 36.331 Radio Resource Control (RRC); Protocol Aspects.
[2] R2-112940, RAN Efficiency Improvement Schemes, Renesas.
[3] R2-113222, PUCCH evaluation, HuaWei
[4] TR 36.213.
[5] 3GPP TR 36.822. Technical Specification Group Radio Access Network.
[6] R2-121484, PUCCH improvements for Diverse Data Applications; Renesas Mobile Europe.
[7] R2-121535, Efficient SR resource allocation on PUCCH; Ericcson, ST-Ericsson;

### SUMMARY

Embodiments of the present disclosure provide apparatuses, methods, computer software and computer program products for improving DRX and scheduling request configuration for diverse data applications.

According to a first aspect of the present disclosure, there is provided a method for use in discontinuous reception in a wireless communications network, the method comprising:

determining information associated with data in a buffer of a user equipment;

causing transmission of the determined information to a network element;

receiving data scheduling request timing interval information for discontinuous reception control from the network element, the received data scheduling request timing interval information being based on the determined information; and

causing transmission of a data scheduling request to the network element at the received data scheduling request timing interval.

According to a second aspect of the present disclosure, there is provided apparatus for use in discontinuous reception in a wireless communications network, the apparatus comprising a processing system adapted to cause the apparatus to:

determine information associated with data in a buffer of a user equipment;

cause transmission of the determined information to a network element;

receive data scheduling request timing interval information for discontinuous reception control from the network element, the received data scheduling request timing interval information being based on the determined information; and

cause transmission of a data scheduling request to the network element at the received data scheduling request timing interval.

According to a third aspect of the present disclosure, there is provided a method for use in discontinuous reception in a wireless communications network, the method comprising:

receiving, from a user equipment, information associated with data in a buffer of the user equipment;

setting a data scheduling request timing interval for discontinuous reception control based on the received information; and

causing transmission of data scheduling request timing interval information for discontinuous reception control to the user equipment.

According to a fourth aspect of the present disclosure, there is provided apparatus for use in discontinuous reception in a wireless communications network, the apparatus comprising a processing system adapted to cause the apparatus to:

receive, from a user equipment, information associated with data in a buffer of the user equipment;

set a data scheduling request timing interval for discontinuous reception control based on the received information; and

cause transmission of data scheduling request timing interval information for discontinuous reception control to the user equipment.

According to a fifth aspect of the present disclosure, there is provided computer software adapted to perform the method of the first aspect and/or the third aspect of the present disclosure.

According to a sixth aspect of the present disclosure, there is provided a computer program product comprising a (non-transitory) computer-readable storage medium having computer readable instructions stored thereon, the computer readable instructions being executable by a computerised device to cause the computerised device to perform the method of the first aspect and/or the third aspect of the present disclosure.

According to embodiments, there is provided an apparatus, which comprises determination means for determining information of data in a buffer, transmission means for causing the determined information to be transmitted to a network element, reception means for receiving data scheduling request timing interval information for discontinuous reception control from the network element, and transmission means for causing a data scheduling request to be transmitted to the network element at the received data scheduling request timing interval.

According to embodiments, there is provided an apparatus, which comprises reception means for receiving information of data in a buffer of a user equipment from the user equipment, setting means for setting a data scheduling request timing interval for discontinuous reception control based on the received information, and transmission means for causing data scheduling request timing interval information for discontinuous reception control to be transmitted to the user equipment.

Advantageous further developments or modifications of the aforementioned aspects of the present disclosure are set out in the dependent claims.

According to embodiments of the present disclosure, the number of scheduling request SR transmission in the uplink UL due to periodic SR configuration and non-periodic packet arrival may be reduced, hence improving the management efficiency in UL control channel resource, which enables an improved scheduling mechanism in using data scheduling request DSR, temporary scheduling request TSR and random access channel scheduling request RSR, for example.

Further features and advantages of embodiments will become apparent from the following description of preferred embodiments, given by way of example only, which is made with reference to the accompanying drawings.

### BRIEF DESCRIPTION OF DRAWINGS

For a more complete understanding of embodiments of the present disclosure, reference is now made to the following description taken in connection with the accompanying drawings in which:

FIG. 1 shows a principle flowchart of an example method according to embodiments of the present disclosure which may be implemented in a user equipment UE;

FIG. 2 shows a principle configuration of an example apparatus according to embodiments of the present disclosure;

FIG. 3 shows a principle flowchart of an example method according to embodiments of the present disclosure which may be implemented in a base station eNB;

FIG. 4 shows a principle configuration of an example apparatus according to embodiments of the present disclosure;

FIG. 5 shows a scheme of a packet arrival trigger according to embodiments of the present disclosure;

FIG. 6 shows a further scheme of a packet arrival trigger according to embodiments of the present disclosure;

FIG. 7 shows a further scheme of a packet arrival trigger according to embodiments of the present disclosure; and

FIG. 8 shows a scheme of a discontinuous reception DRX Cycle according to 3GPP Release 8, TR 36.321.

Aspects of the present disclosure will be described herein below. More specifically, aspects of the present are described hereinafter with reference to particular non-limiting examples of embodiments of the present disclosure. A person skilled in the art will appreciate that embodiments are by no means limited to these examples, and may be more broadly applied.

It is to be noted that the following description of the present disclosure and its embodiments mainly refers to specifications being used as non-limiting examples of network configurations and deployments. Namely, the present disclosure and its embodiments are mainly described in relation to 3GPP™ specifications being used as non-limiting examples of network configurations and deployments. In particular, a LTE™/LTE-Advanced™ communication system is used as a non-limiting example for the applicability of thus described embodiments. As such, the description of embodiments given herein specifically refers to terminology which is directly related thereto. Such terminology is only used in the context of the presented non-limiting examples, and does naturally not limit embodiments in any way. Rather, any other network configuration or system deployment, etc. may also be utilized as long as compliant with the features described herein. Some examples of network configurations or system deployments are the universal mobile telecommunications system (UMTS) radio access network (UTRAN or E-UTRAN), long term evolution (LTE, known also as E-UTRA), long term evolution advanced (LTE-A), Wireless Local Area Network (WLAN) based on IEEE (Institute of Electrical and Electronics Engineers) 802.11 standard, worldwide interoperability for microwave access (WiMAX), Bluetooth™, and systems using ultra-wideband (UWB) technology.

Hereinafter, various embodiments and implementations of the present disclosure and its aspects or embodiments are described using several alternatives. It is generally noted that, according to certain needs and constraints, all of the described alternatives may be provided alone or in any conceivable combination (also including combinations of individual features of the various alternatives).

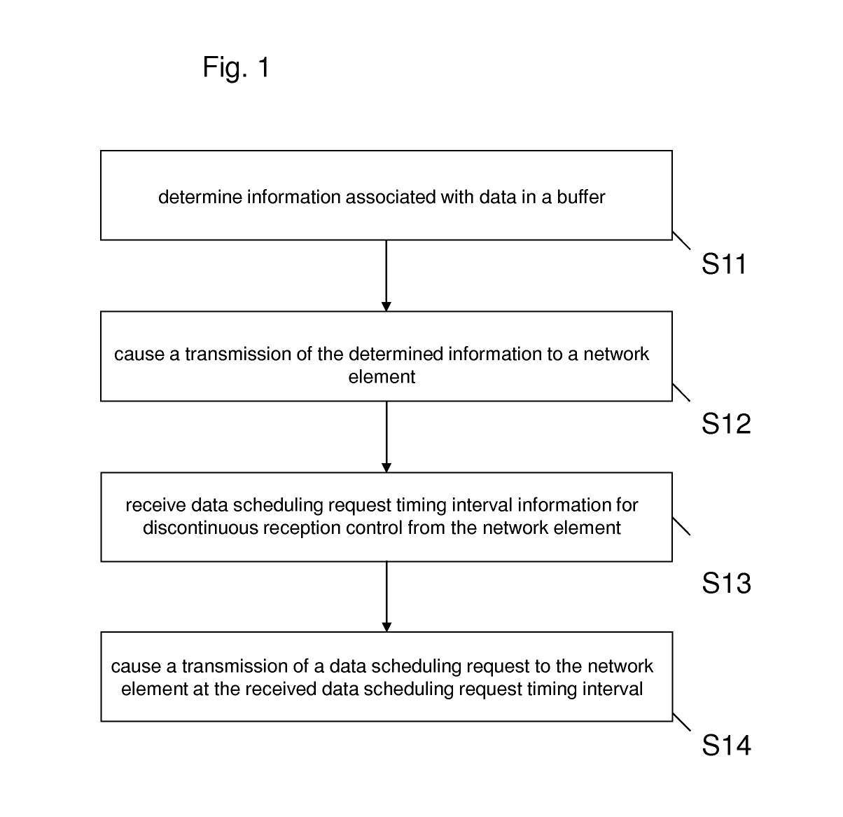

FIG. 1 shows a principle flowchart of a method according to embodiments of the present disclosure.

In Step S11, information associated with data in a buffer is determined.

In Step S12, the determined information is caused to be transmitted to a network element.

In Step S13, data scheduling request timing interval information for discontinuous reception control is received from the network element.

In Step S14, a data scheduling request is caused to be transmitted to the network element at the received data scheduling request timing interval.

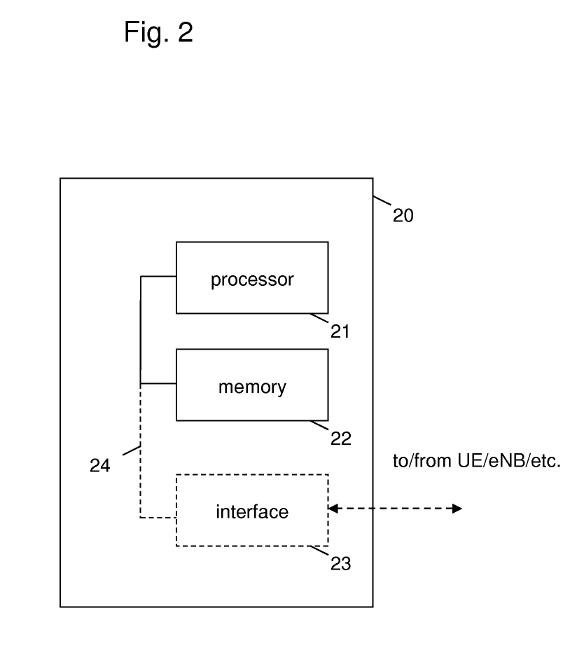

FIG. 2 shows a principle configuration of an example apparatus according to embodiments of the present disclosure. The apparatus 20 comprises a processing system and/or at least one processor 21 and at least one memory 22 including computer program code, which are connected by a bus 24 or the like. As indicated with a dashed line in FIG. 2, an interface 23 may optionally be connected to the bus 24 or the like, which enables communication e.g. to/from a network entity, a base station, a UE, or the like. The processing system and/or at least one memory and the computer program code are arranged to, with the at least one processor, cause the apparatus at least to perform determining information associated with data in the buffer, cause a transmission of the determined information to a network element, receiving data scheduling request timing interval information for discontinuous reception control from the network element, and cause a transmission of a data scheduling request to the network element at the received data scheduling request timing interval.

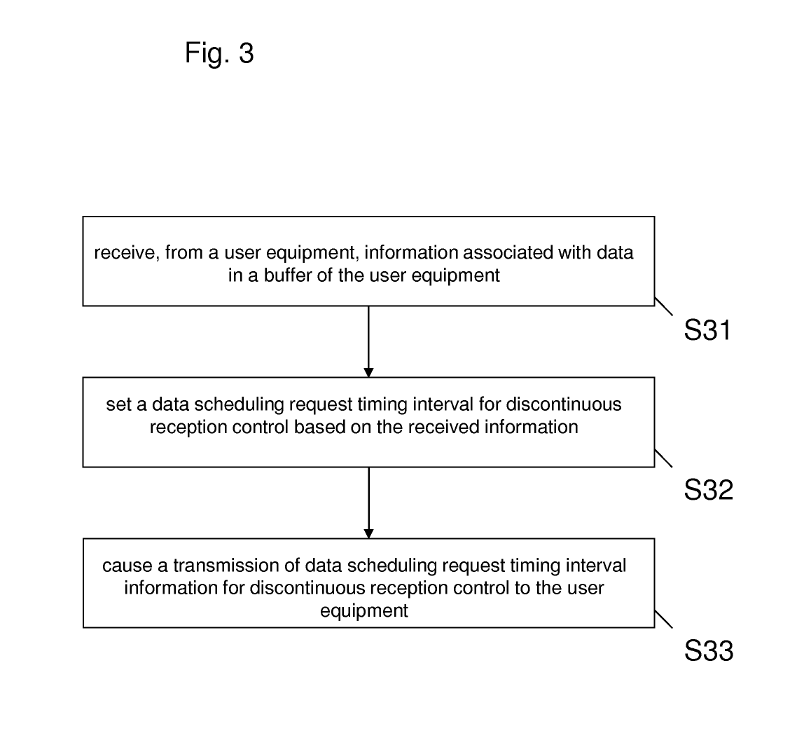

FIG. 3 shows a principle flowchart of an example method according to embodiments of the present disclosure.

In Step S31, information associated with data in a buffer of a user equipment is received from the user equipment.

In Step S32, a data scheduling request timing interval for discontinuous reception control is set based on the received information.

In Step S33, data scheduling request timing interval information for discontinuous reception control is caused to be transmitted to the user equipment.

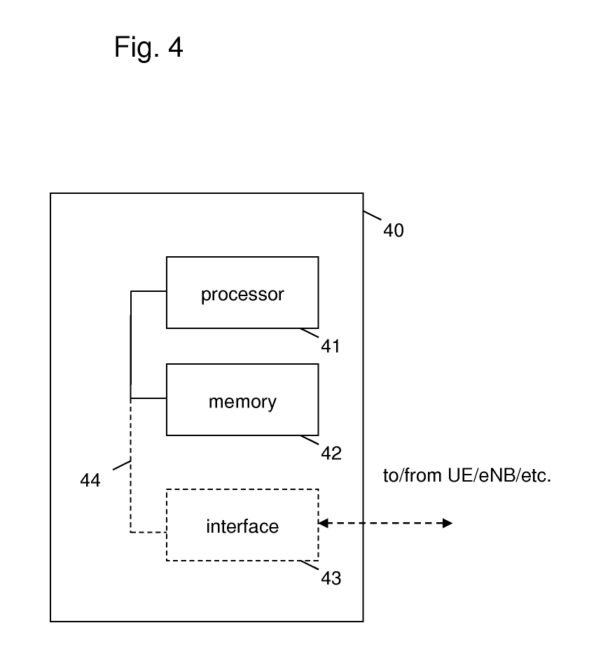

FIG. 4 shows a principle configuration of an example apparatus according to embodiments of the present disclosure. The apparatus 40 comprises a processing system and/or at least one processor 41 and at least one memory 42 including computer program code, which are connected by a bus 44 or the like. As indicated with a dashed line in FIG. 4, an interface 43 may optionally be connected to the bus 44 or the like, which enables communication e.g. to/from a user equipment, a network entity, a base station, or the like. The processing system and/or at least one memory and the computer program code are arranged to, with the at least one processor, cause the apparatus at least to perform receiving information associated with data in a buffer of a user equipment from the user equipment, setting a data scheduling request timing interval for discontinuous reception control based on the received information, and cause a transmission of data scheduling request timing interval information for discontinuous reception control to the user equipment.

According to embodiments of the present application, it is possible to use a longer period scheduling request SR to decrease the occupied SR resource in case there is no frequent data transmission. Further, it is possible to use a temporary SR (TSR) to temporarily shorten the SR interval without requiring a very high physical uplink control channel PUCCH load. The TSR may be effective until a timer expires.

According to embodiments of the present disclosure, two data scheduling request DSR configurations may be used for a user equipment UE, one for a longer DSR, and another shorter DSR period as TSR.

In embodiments, the UE may send at least one of average data size information, average data period information and interval arrival time information of data in the buffer to an eNB to help the eNB to configure an appropriate longer DRX and longer DSR configuration.

Together with the average data size information, average data period information and interval arrival time information of data in the buffer sent by the UE, sending a SR may enable an appropriate longer DRX and longer DSR configuration in response to the SR request so that an appropriate DRX with a flexible start offset parameter drxStartOffset can be set based on such a learning procedure of the scheduler, which is described later in more detail.

The dsrTSR-StartOffset is a new DRX parameter. Several options can be included therefore, such as T [ms]. Even if embodiments of the present disclosure are not limited to a specific value of T [ms], the reason why T [ms] could be an appropriate parameter for the dsrTSR-StartOffset is that one UE's Tx/Rx and retransmission can be finished within the time period of T [ms]. In current LTE systems, if a UE starts transmission at a time n, the UE will get a response at a time n+4, and if the response is negative, then the UE may need to retransmit the same packet another 4 ms later. Therefore, in LTE a value of about T=20 ms may be an appropriate interval for the UE to consider another new packet transmission in TSR.

In embodiments, average data size information, average data period information and interval arrival time information associated with data in a buffer sent by a UE may be attained by automatic measuring in a certain time duration (similar to the way to find the traffic characteristic), or could already be stored in network and/or UE side/s with some options. The UE may send the information by radio resource control RRC signaling or PUCCH together with SR. That means, for example, that the information from UE side could be a measurement in a certain time duration which needs to be sent to eNB, or it could be a previous measurement that is stored in eNB and/or UE side/s. It is to be noted that for the latter case, e.g. if it was stored in the network, then the UE may not need to send the information.

According to embodiments of the present application, alternative ways for configuring data scheduling request DSR, temporary scheduling request TSR and random access channel scheduling request RSR are shown below.
The interval of DSR and the first TSR opportunity is defined by appropriate selection of drxTSR-startoffset.
TSR is configured in time at the first DSR opportunity+drxTSR-startoffset [ms]. In some embodiments, an appropriate drxTSR-startoffset parameter might be about 20 ms. TSR resource is automatically released after another drxTSR-inactivityTimer ms when associated packet transmission is finished. In some embodiments, a numerical value for drxTSR-inactivityTimer can be equivalent to drx-InactivityTimer as is specified in 3GPP 36.321.
Configured TSR resources can be automatically released for other UEs to use if no data arrival occurs during drxTSR-InactivityTimer. Packets arriving after TSR resource release can use RSR.

The above described methods may also be applicable for some Machine-Type Communications (MTC) use cases. Details and other examples of alternative ways are shown in the following.

For example in LTE, the scheduler is placed in a base station eNB and the Medium Access Control MAC layer. To schedule the users in the uplink, the scheduler sends uplink grants on the PDCCH specifying which resource blocks RB and which transport format to use.

In a current system, the SR is sent based on a scheduled time slot/period by a UE in case there is resource available. In some embodiments, an appropriate DRX and SR are configured based on data assisted information. In order to save the UL resource it may be optimal to use two DSR configurations for a device (e.g. a smart phone EDDA device), one for longer DSR and another short DSR period as TSR, for example.

In some embodiments, the UE may send average data size and averaged IAT information to an eNB to help the eNB configure an appropriate longer DRX and longer DSR configuration.

Together with the average data size and average IAT information sent by the UE, sending SR may enable an appropriate longer DRX and longer DSR configuration in response to the SR request so that an appropriate DRX with flexible drxStartOffset can be set based on a learning procedure of the scheduler.

According to embodiments, in the above mentioned learning procedure of a scheduler, the UE sends its measured application information as assistant information to the scheduler of the eNB, to trigger the eNB to schedule appropriate parameters at the UE. The UE could measure the application data transmission characteristics, for example, the average data size and average IAT information within a time interval, and the measured information could be sent to the eNB. When the eNB receives this measured data buffer information, the eNB could select an appropriate DRX cycle and associated appropriate SR (in this document it refers to DSR) configuration for the UE and configure such appropriate DRX and SR at the UE. If the packet arrives at the data buffer, it could trigger the UE to send a SR request to the eNB, when the eNB receives this SR, the eNB may enable configured SR resource configuration; otherwise, if there was no SR request sent by the UE, the configured SR resources could be scheduled for other usages.

In some embodiments, a second TSR configuration may be used with a short DSR configuration to cope with the data packet arriving at the long interval of two long DSR opportunities time, referred to as temporary SR.

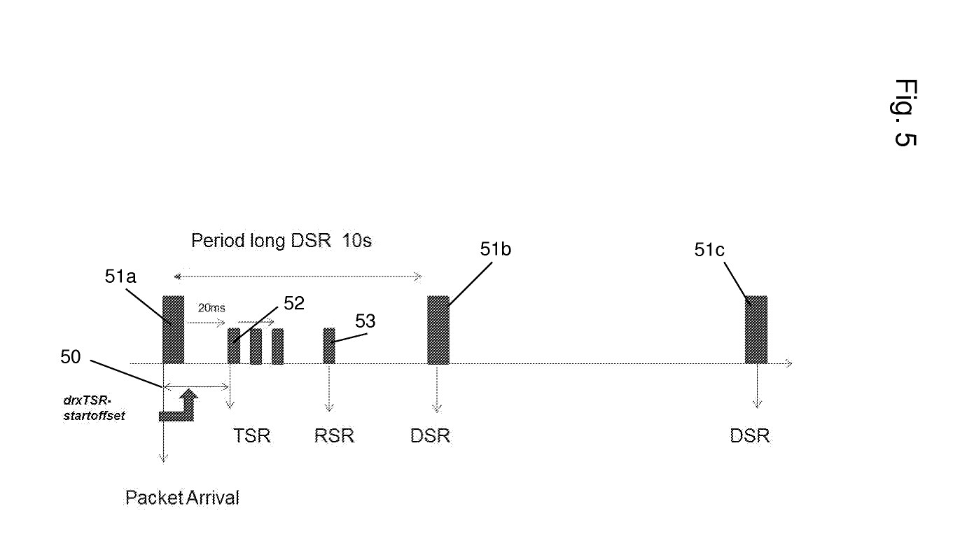

In the following, several example ways according to embodiments of the present disclosure for configuring the resource of DSR, TSR and RSR are shown with reference to FIGS. 5 to 7.

FIG. 5 shows a scheme of a packet arrival trigger according to alternative method 1, which shows one embodiment of the present disclosure.

Alternative Method 1: DSR+TSR+RSR
The interval of DSR 51a, 51b, 51c and the first TSR opportunity 52 is defined by appropriate selection of drxTSR-startoffset 50. This might be a new DRX parameter especially for TSR configuration, so that when data arrival in the buffer triggered one of the configured TSR and at the same time UE is back in active mode.
TSR is configured in time at the first DSR opportunity+drxTSR-startoffset [ms]. An appropriate drxTSR-startoffset parameter might be T [ms], for example. Data arrived before a configured TSR opportunity will have to wait in the data buffer until there is TSR resource available. TSR resource is automatically released after another drxTSR-inactivityTimer [ms] when associated packet transmission is finished. The drxTSR-inactivityTimer is another new DRX parameter especially for TSR. In some embodiments, a numerical value for drxTSR-inactivityTimer can be equivalent to drx-InactivityTimer as is specified in 3GPP 36.321.
Configured TSR resource can be automatically released for other UE to use if no data arrival during drxTSR-InactivityTimer. Packets arrive after TSR resource release can use RSR 53, as shown in FIG. 5.

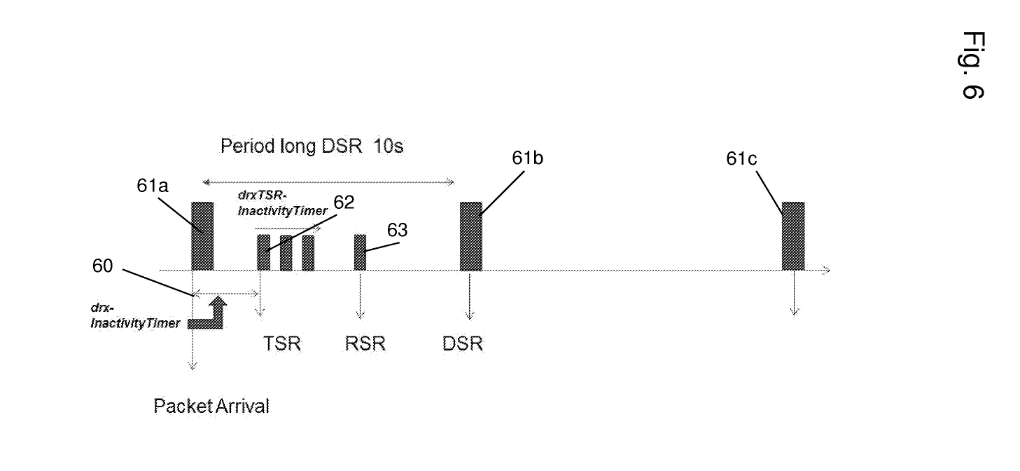

FIG. 6 shows a further scheme of a packet arrival trigger according to alternative method 2, which shows one embodiment of the present disclosure.

### Alternative Method 2: DSR+TSR+RSR

The interval of DSR 61a, 61b, 61c and the first TSR opportunity 62 is defined by appropriate selection of existing DRX parameter drx-InactivityTimer 60. So that after one long DRX /or DSR opportunity (since they are configured as identical), and if there is pending DSR UE will be in active mode until drx-InactivityTimer is due; then the UE will be in power saving mode.
The TSR could be triggered by data arrival in the interval of DSR and the first TSR opportunity and the TSR configuration is within a time window of drxTSR-InactivityTimer. Here drxTSR-InactivityTimer is a new DRX parameter. In some embodiments, a numerical value for the drxTSR-InactivityTimer options can be equivalent to the existing data array options in drx-InactivityTimer as specified in 3GPP 36.321. The network might select one of the options as drxTSR-InactivityTimer which is not necessarily the same as DSR's drx-InactivityTimer in scale. TSR resource is automatically released outside of the window. Data arrival beyond the TSR window will be using RACH (RSR 63) to send the SR, as is shown in FIG. 6.

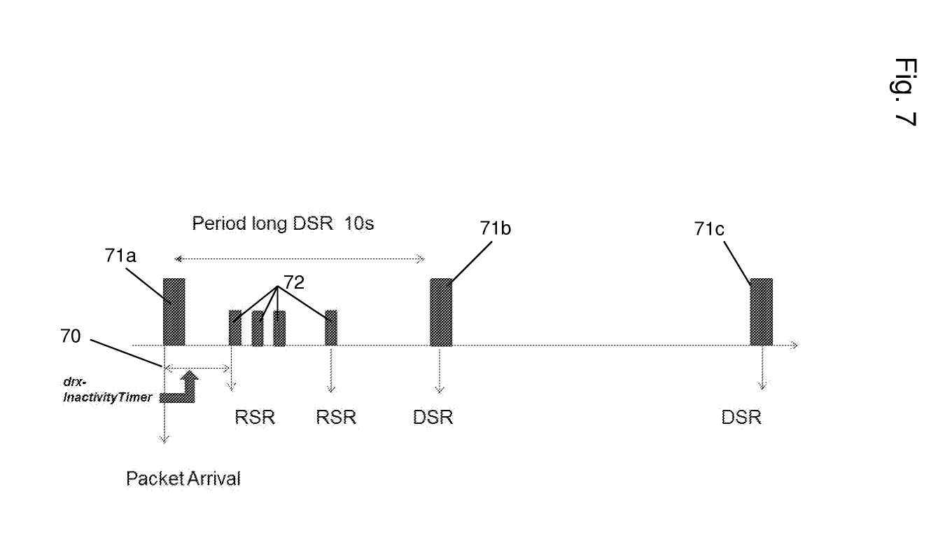

FIG. 7 shows a further scheme of a packet arrival trigger according to alternative method 3, which shows one embodiment of the present disclosure.

Alternative Method 3: DSR+RSR
Another alternative from method 1 is that in the long DRX/DSR interval 71a, 71b, 71c where the UE is supposed to be in power-saving mode, there is no configured UL SR resource configured, and packets arriving in the interval will have to use RACH to send SR (RSR 72) and get the UL grant, as is shown in FIG. 7.
When SR is triggered using RSR 72, the UE will be back to active mode from power saving mode and last until drxTSR-Inactivity Timer 70 is due.

Alternative method 3 can be suitable for a traffic application which has more periodic oriented features, as it is configured with less SR resource in one UE; but it has to compromise with more higher layer signaling when there are sudden packet arrivals in-between long DSR configurations.

Alternative method 1 and method 2 can be suitable for traffic applications with more intermittent oriented features, as it is configured with more SR resource (in TSR) in one UE; but it has less higher layer signaling when there are sudden packet arrivals in-between long DSR configurations.

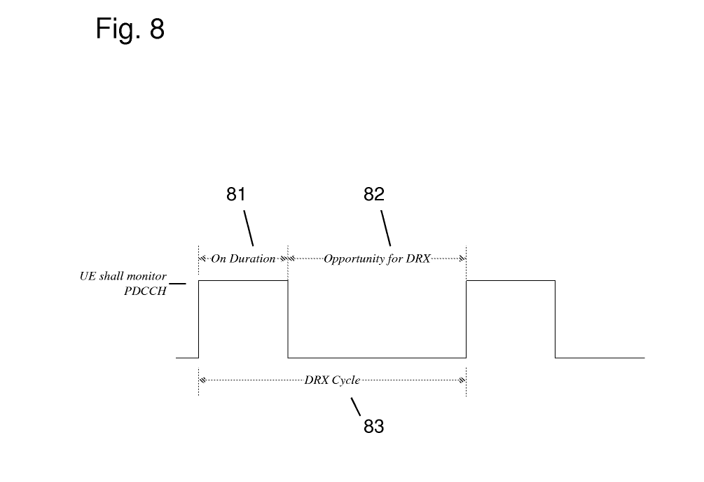

FIG. 8 shows a scheme of a DRX Cycle according to 3GPP Release 8, TR 36.321, where a DRX-cycle 83 is divided into an on-duration section 81 and a section offering an opportunity for DRX 82. During the on-duration section 81, the UE shall monitor the PDCCH.

The drx-InactivityTimer specifies the number of consecutive PDCCH-subframe(s) after successfully decoding a PDCCH indicating an initial UL or DL user data transmission for this UE, which means that a UE can continue to be in active mode for inactivityTimer duration after a UE receives a PDCCH even when the DRX cycle is due.

The idea of using average data size and average IAT information of the data arriving in buffers instead of at one application case may obtain a relatively better suited DRX configuration for a UE. More importantly, even when there is only one application running on a device at one time, using average data size and average IAT information of the data arriving in buffers may provide good DRX configuration for saving power consumption purposes, for example.

In some embodiments, the RSR are used after TSR resource release for handling the packets arriving at the unexpected time durations. Since the DRX and DSR is configured based on statistical information of data, e.g. using average data size and average IAT information of the data arriving in buffer, the DRS may be expected to handle the most packet transmissions of the UE. TSR may be used to handle the second most often packet transmissions of the UE. And the RSR may be used to handle the packets outside of the region of DSR, TSR.

Embodiments of the present disclosure, mainly deal with non-periodic traffic applications. In some embodiments, the averaged data size and average period of data or average interval arrival time of data in a buffer may be used, which might be applicable from one or more applications so that eNB can define an appropriate DRX for the UE. The averaged data size and averaged interval arrival time are useful assistant information from a UE. As for some of the applications such as intermittent applications, the shortest message interval might result in a DRX configuration which consumes more UE powers.

Furthermore, according to embodiments of the present disclosure, PUCCH resource configuration for scheduling request (SR) may be designed.

Since embodiments of the present application deal with intermittent data transmission, the main configured SR (so called DSR) resources might be not enough. To cope with data arriving in-between the configured SR resources, in embodiments of the present disclosure temporary SR and RACH SR are used.

The temporary SR is designed to allow a UE to send its data in a certain window length in which the UE is allowed to go back to active mode. The window length is defined by a new DRX parameter in embodiments of the present disclosure.

It may be designed such that when data arrives in-between DSR and TSR but before the window length the data can be accumulated in a buffer until the TSR resource is available and sent. Data arriving outside the window would use RSR.

In some embodiments, the TSR parameter can be a short period of SR that is selected from rel.8/9 SR configurations.

According to embodiments of the present disclosure, the interval of DSR and the first TSR opportunity is defined by appropriate selection of a timer T (e.g. T=20 ms). Furthermore, it is defined how to allocate resources using DSR, TSR and RSR.

A combination of DSR, TSR and RSR may provide efficient scheduling mechanisms to handle the packets arriving at unexpected times. Since the DRX and DSR is configured based on statistical information of data (e.g. using average data size and average IAT information of the data arriving in the buffer), the DSR is expected to handle the most packet transmissions of the UE. TSR is designed to handle the second most often packet transmissions of the UE, and the RSR should be used to handle the packets outside of the region of DSR, TSR.

Some embodiments are described based on an LTE-A system but embodiments may be applied to other radio access technologies such as LTE™, WiFi™, WLAN, UMTS, High Speed Packet Access HSPA, if in-device co-existence indicating is foreseen.

A device may comprise a user equipment, a terminal, a mobile phone, a laptop, a smartphone, a tablet PC, or any other device that may attach to the mobile network. A network element may be a NodeB, an eNodeB or any other base station of a radio network, for example.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that embodiments of the present disclosure provide, for example a controller apparatus such as a user equipment, a UE, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that embodiments of the present disclosure provide, for example a base station apparatus such as a NodeB or an eNodeB, or a component thereof, an apparatus embodying the same, a method for controlling and/or operating the same, and computer program(s) controlling and/or operating the same as well as mediums carrying such computer program(s) and forming computer program product(s).

According to embodiments of the present disclosure, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processing system or processor (or multiple processors) or portion of a processor and its (or their) accompanying software and/or firmware, any integrated circuit, or the like.

Generally, any procedural step or functionality is suitable to be implemented as software/firmware or by hardware without changing the ideas of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independent of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

### LIST OF ABBREVIATIONS

DL Downlink
eNB Enhanced NodeB
LTE Long Term Evolution
LTE-A Long Term Evolution Advanced
UE User Equipment
UL Uplink
MAC Medium Access Control
CE control element
RF Radio Frequency
UTRAN Universal terrestrial radio access network
E-UTRAN Enhanced UTRAN
TX Transmit
RX Receive
3GPP Third generation partnership project
TS Technical Specification
RRC Radio resource control
MAC Medium access control
RAN Radio access network
RAT Radio access technology
IE Information Element
MAC Media Access Control
PDCCH Physical Downlink Control CHannel
PRACH Physical Random Access CHannel
PRB Physical Resource Block
PUCCH Physical Uplink Control CHannel
PUSCH Physical Uplink Shared Channel
DSR Data Scheduling Request
TSR Temporary Scheduling Request
RSR RACH Scheduling Request
IAT interval arrival time

1. A method for use in discontinuous reception in a wireless communications network, the method comprising:
determining information associated with data in a buffer of a user equipment;
causing transmission of the determined information to a network element;
receiving data scheduling request timing interval information for discontinuous reception control from the network element, the received data scheduling request timing interval information being based on the determined information; and
causing transmission of a data scheduling request to the network element at the received data scheduling request timing interval.

2. The method according to claim 1, further comprising:
receiving temporary scheduling request timing information comprising temporary scheduling request start offset information from the network element; and
causing transmission of a temporary scheduling request to the network element after elapse of the received temporary scheduling request start offset from a data scheduling request timing in case data is to be transmitted to the network element.

3. The method according to claim 1, further comprising:
receiving temporary scheduling request inactivity timer information from the network element;
starting the temporary scheduling request inactivity timer after elapse of the received temporary scheduling request start offset from the data scheduling request timing; and
prohibiting transmission of the temporary scheduling request to the network element after elapse of the temporary scheduling request inactivity timer.

4. The method according to claim 1, further comprising causing transmission of a random access channel scheduling request to the network element in case data is to be transmitted to the network element after elapse of the temporary scheduling request inactivity timer and before a subsequent data scheduling request timing.

5. The method according to claim 1, wherein the information associated with data in the buffer is transmitted by radio resource control signaling or via a physical uplink control channel.

6. The method according to claim 1, wherein the information associated with data in the buffer comprises at least one of average data size information, average data period information and interval arrival time information of data in the buffer.

7. The method according to claim 6, wherein the average data size information and at least one of average data period information and interval arrival time information of data in the buffer is determined by measuring buffer activity during a preset time.

8-10. (canceled)

11. An apparatus for use in discontinuous reception in a wireless communications network, the apparatus comprising a processing system adapted to cause the apparatus to:
determine information associated with data in a buffer of a user equipment;
cause transmission of the determined information to a network element;
receive data scheduling request timing interval information for discontinuous reception control from the network element, the received data scheduling request timing interval information being based on the determined information; and
cause transmission of a data scheduling request to the network element at the received data scheduling request timing interval.

12. The apparatus according to claim 11, wherein the processing system is further adapted to cause the apparatus to:
receive temporary scheduling request timing information comprising temporary scheduling request start offset information from the network element; and
cause transmission of a temporary scheduling request to the network element after elapse of the received temporary scheduling request start offset from a data scheduling request timing in case data is to be transmitted to the network element.

13. The apparatus according to claim 11, wherein the processing system is further adapted to cause the apparatus to:
receive temporary scheduling request inactivity timer information from the network element;
start the temporary scheduling request inactivity timer after elapse of the received temporary scheduling request start offset from the data scheduling request timing; and
prohibit transmission of the temporary scheduling request to the network element after elapse of the temporary scheduling request inactivity timer.

14. The apparatus according to claim 11, wherein the processing system is further adapted to cause the apparatus to cause transmission of a random access channel scheduling request to the network element in case data is to be transmitted to the network element after elapse of the temporary scheduling request inactivity timer and before a subsequent data scheduling request timing.

15. The apparatus according to claim 11, wherein the information associated with data in the buffer is transmitted by radio resource control signaling or via a physical uplink control channel.

16. The apparatus according to claim 11, wherein the information associated with data in the buffer comprises at least one of average data size information, average data period information and interval arrival time information of data in buffer.

17. The apparatus according to claim 16, wherein the average data size information and at least one of average data period information and interval arrival time information of data in the buffer is determined by measuring buffer activity during a preset time.

18. The apparatus according to claim 12, wherein the temporary scheduling request start offset is set to 20 ms.

19. The apparatus according to claim 13, wherein the value of the temporary scheduling request inactivity timer is set equal to the value of a discontinuous reception inactivity timer.

20. The apparatus according to claim 11, wherein the network element comprises a base station.

21. The apparatus according to claim 11, wherein the apparatus is comprised in a user equipment or a mobile phone.

22. The apparatus according to claim 11, wherein the apparatus belongs to a long-term evolution system or a long-term evolution advanced system.

23-30. (canceled)

31. An apparatus for use in discontinuous reception in a wireless communications network, the apparatus comprising a processing system adapted to cause the apparatus to:
receive, from a user equipment, information associated with data in a buffer of the user equipment;
set a data scheduling request timing interval for discontinuous reception control based on the received information; and
cause transmission of data scheduling request timing interval information for discontinuous reception control to the user equipment.

32-42. (canceled)
